(19) United States
(12) Patent Application Publication
(10) Pub. No.: US 2004/0183937 A1
(43) Pub. Date: Sep. 23, 2004

(54) Color imaging system and a method in a color imaging system

(75) Inventors: Jarkko Viinikanoja, Tampere (FI); Hannu Kakkori, Tampere (FI); Eero Salmelin, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/740,909

(22) Filed: Dec. 19, 2003

(30) Foreign Application Priority Data
Dec. 20, 2002 (FI) 20022245

(51) Int. Cl. H04N 5/225

(52) U.S. Cl. 348/340; 348/207.99

(57) ABSTRACT

The invention refers to a color imaging system (20) comprising at least one electronic color image sensor (11) and an imaging lens system (13) forming an optical image on the image sensor, the image sensor having substantially different spatial sampling frequencies for at least two different colors. According to the invention, the imaging system (20) comprises a color specific aperture stop (30) defining substantially different aperture sizes for the at least two different colors. The invention also refers to a method in a color imaging system. The invention leads to improved image quality and better sensitivity in an electronic imaging devices without requiring the use of complex and/or expensive optical components. It allows economical maximizing of the performance of the existing lens system and image sensor components especially in simple and compact digital imaging devices.

### CROSS-REFERENCE TO RELATED APPLICATIONS

This application claims priority under 35 USC §119 to Finnish Patent Application No. 20022245 filed on Dec. 20, 2002.

### FIELD OF THE INVENTION

The present invention relates to a color imaging system based on the use of an electronic image sensor and imaging lens system forming an optical image on the image sensor. The invention also relates to a method in a color imaging system.

In the following, an electronic imaging system refers in its simplest form to a system, apparatus or device comprising at least one electronic image sensor and a lens or lens system for forming an optical image on said sensor.

### BACKGROUND OF THE INVENTION

Generally speaking, an element in an optical system that determines the amount of light reaching an image is known as an aperture stop. In a conventional camera an adjustable leaf diaphragm, usually located behind the first few optical elements of a multi-element camera lens, functions as an aperture stop. In simple fixed focus cameras without adjustable optics, the aperture stop is in its simplest form typically just a small hole in an optically opaque material arranged in front of the camera lens.

Especially in simple and economical digital cameras, the diameter of the lens is kept small in order to reduce cost of the optics, but also in order to achieve lightweight and compact size. Because the marginal rays with lower f-number suffer from the optical aberrations caused by the lens more severely than the higher f-number rays travelling closer to the optical axis of the lens, as well known in the art, the aperture stop needs to be kept small in order to preserve reasonable image quality. This on the other hand leads to rather poor sensitivity in low light conditions. A larger aperture stop would improve sensitivity, but in order to preserve the image quality a higher quality, and therefore also a more expensive lens or lens system would be required.

### SUMMARY OF THE INVENTION

The main purpose of the present invention is to introduce a novel and simple solution for the aperture stop in an electronic imaging system. The invention is specifically intended to be applied in economical and compact digital cameras and corresponding electronic imaging devices, which cannot rely on the use of expensive and substantially aberration free lens systems. The invention effectively solves those problems which are basically caused when a fixed f-number is used for all colors in a color resolving imaging system. These problems are related both to the sensitivity (amount of light) of the imaging and to the overall quality of the recorded color image (sharpness of image).

The basic gist of the invention relates to the observation that modern color image sensors, for example CCD (Charged Coupled Device) or CMOS (Complementary Metal Oxide Semiconductor) matrix sensors, have different spatial sampling frequencies for different primary colors. A typical one chip RGB (Red-Green-Blue) color CDD sensor is based on the use of the so-called Bayer color matrix layout. In this well-known layout a single “virtual” color pixel is formed from a group of altogether four primary color pixels arranged in a 2×2 matrix formation: two diagonally positioned green pixels with one red and one blue pixel. In such a pixel layout the number of green pixels in the sensor is two times higher than the number of red or blue pixels. Therefore, the spatial sampling frequency of the green primary color is twice as high as that of the other two primary colors.

According to the invention, the optical performance of a color resolving imaging system, where at least two primary colors have different spatial sampling frequencies, can be effectively optimized by arranging the aperture stop for said at least two primary colors to have different properties. For that color for which the image sensor has the highest spatial sampling frequency, and thus requiring highest MTF (Modulation Transfer Function) performance from the imaging optics, a smaller aperture stop size (diameter) is selected and, correspondingly, other way round. Each primary color may be selected to have an optimal aperture stop size in order to maximize the quality of the recorded image. Further, if necessary the aperture stop may also comprise spectral filtering properties in order to balance the amount of light between different primary colors in order to reduce the requirements for the dynamic range of the image sensor.

According to one interpretation the invention can be considered as a color specific aperture stop, which defines different f-numbers for those primary colors that have different spatial sampling frequencies. It is important to notice that the final quality of the recorded image depends on both the performance of the image sensor and that of the imaging optics. The invention helps to match these performances separately for each primary color in order to achieve an optimized imaging system.

According to one embodiment of the invention the color specific aperture stop takes a form of an optically opaque plate, which carries optically transmissive circular areas arranged coaxially with respect to the optical axis of the plate. These transmissive areas, which have mutually different diameters and mutually different spectral transmissive properties define different f-numbers for at least those primary colors, which have different spatial sampling frequencies.

According to another embodiment of the invention the aforementioned plate further comprises an optical infrared (IR) cut-off filter.

Besides improving the image quality, an important benefit of the invention is that the color specific aperture stop allows the image sensor to collect more light on those colors, which have the lowest spatial sampling frequencies. In other words, with these colors a larger aperture stop diameter can be used without degrading the image quality. Luckily, in practice in the case of a RGB image sensor these colors are the red and blue primary colors, which typically have smaller sensitivity than the green color. Thus, these colors gain from the use of lower f-number aperture stop in terms of sensitivity.

The solution according to the invention leads to improved image quality and better sensitivity in an electronic imaging device without requiring the use of complex and/or expensive optical components. It allows economical maximizing of the performance of the existing lens and image sensor components especially in simple and compact digital imaging devices.

To attain these purposes, the electronic imaging system based on the use of at least one electronic image sensor and equipped with a color specific aperture stop is primarily characterized by an image sensor having substantially different spatial sampling frequencies for at least two different colors, wherein the imaging system further comprises a color specific aperture stop defining substantially different aperture sizes for said at least two different colors. The method according to the invention is primarily characterized by an image sensor having substantially different spatial sampling frequencies for at least two different colors, wherein substantially different aperture stop sizes are defined for said at least two different colors using a color specific aperture stop. The other dependent claims present some preferred embodiments of the invention.

The preferred embodiments of the invention and their benefits will become more apparent to a person skilled in the art through the description hereinbelow, and also through the appended claims.

### DESCRIPTION OF THE DRAWINGS

In the following, the invention will be described in more detail with reference to the appended drawings, in which

FIG. 1 illustrates schematically a basic electronic imaging system with a prior art type aperture stop and a separate IR filter,

FIG. 2 illustrates schematically a prior art type aperture stop,

FIG. 3 illustrates schematically a RGB-type image sensor with Bayer color matrix layout,

FIG. 4 illustrates schematically an electronic imaging system equipped with a color specific aperture stop and integrated IR filter according to the invention,

FIG. 5 illustrates schematically some alternative positions of the color specific aperture stop in an electronic imaging system according to the invention,

FIG. 6 illustrates schematically one possible embodiment of the color specific aperture stop according to the invention, and

FIG. 7 illustrates schematically another possible embodiment of the color specific aperture stop according to the invention.

### DETAILED DESCRIPTION OF THE INVENTION

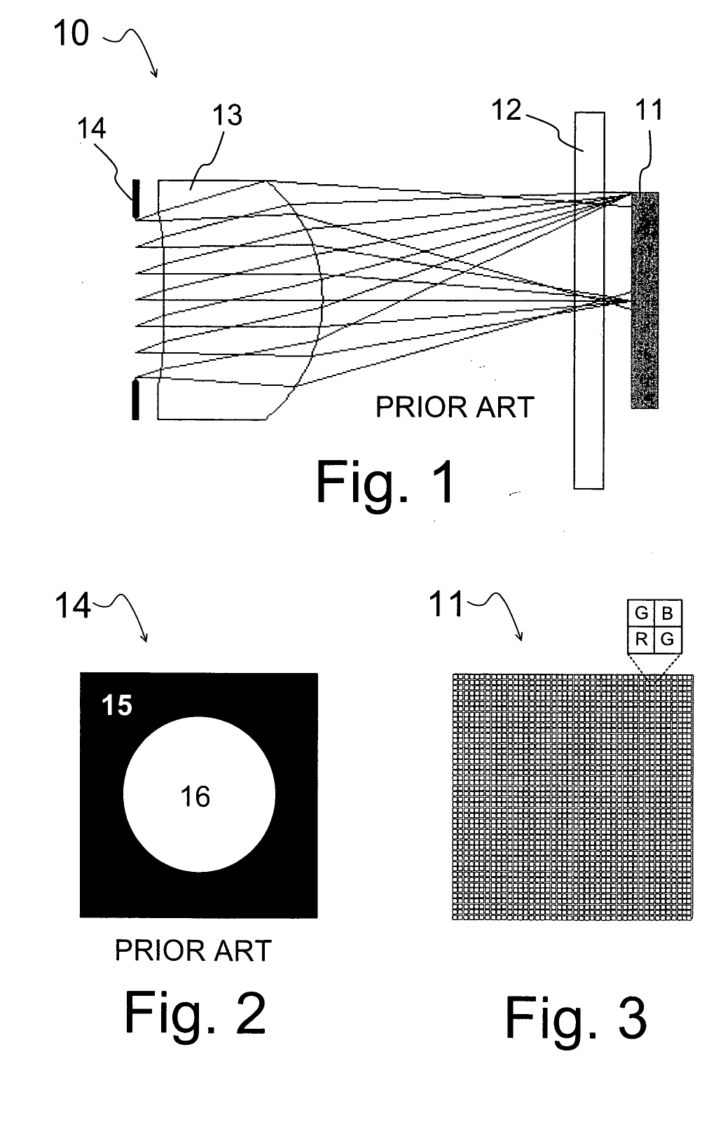

FIG. 1 illustrates schematically a basic electronic imaging system 10 comprising a color RGB-type image sensor 11 and a single imaging lens 13 together with a prior art type aperture stop 14 and a separate IR filter 12.

FIG. 2 illustrates in more detail the basic construction of the aperture stop 14. A typical standard aperture stop 14 is constructed from a thin black anodized opaque aluminium plate 15 with a circular aperture hole 16. With such an aperture stop all wavelengths, i.e. all primary colors recorded by the image sensor 11 experience the same fixed f-number.

FIG. 3 illustrates schematically a RGB-type image sensor with the well-known Bayer color matrix layout, where a single “virtual” color pixel is formed from a group of altogether four primary color pixels (2×G, 1×R, 1×B) arranged in a 2×2 matrix formation. Because the number of green pixels in the image sensor 11 is twice as much as the number of blue or red pixels, the spatial sampling frequency of the green primary color is higher. Therefore, higher MTF of the lens 13 would be needed for said color, but the prior art type aperture stop provides the same f-number for all primary colors, thus causing the performance of the lens 13 with respect to the optical aberrations to be substantially the same for all primary colors. Therefore, the MTF of the lens 13 is not optimal for individual primary colors but, instead, provides a compromise between different requirements.

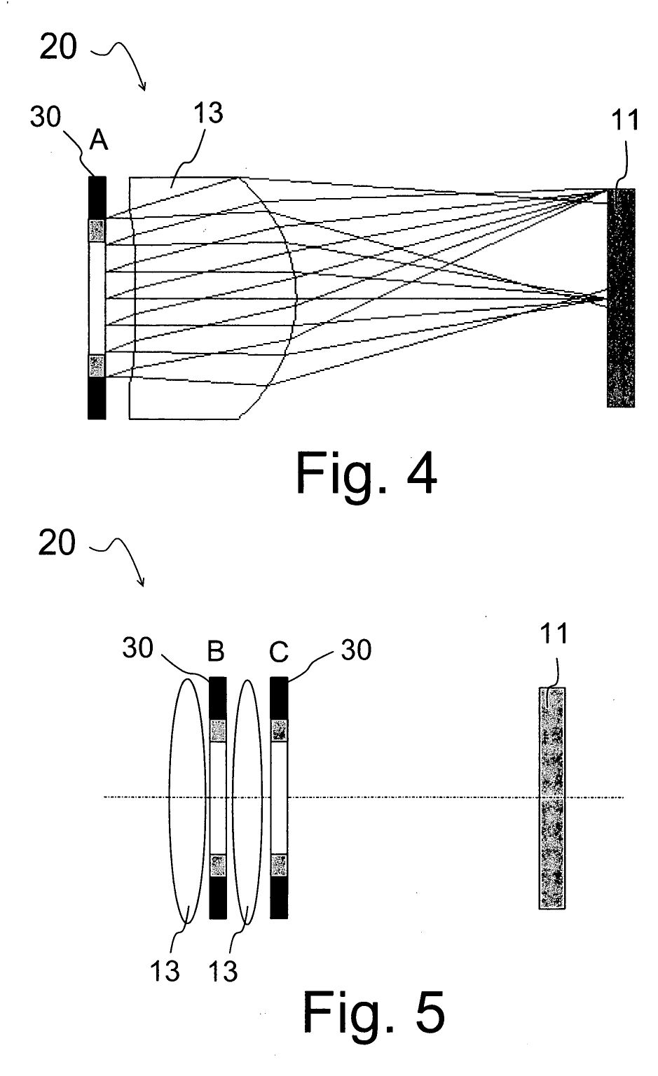

FIG. 4 illustrates schematically an electronic imaging system 20 according to the invention equipped with a color specific aperture stop 30. In this embodiment of the invention the color specific aperture stop 30 is positioned in front of the imaging lens 13 (marked position A) and comprises also an integrated IR filter. Preferably, the color specific aperture stop 30 is installed to the imaging system 20 in such a manner, that it is easily interchangeable with another aperture stop having somewhat different optical properties and optimized, for example, for different lightning conditions.

FIG. 5 illustrates schematically some alternative positions along the optical axis (marked positions B,C) for the color specific aperture stop 30 in an electronic imaging system 20. For clarity, the geometrical beams have not been illustrated in FIG. 5.

It is to be understood that the position of the aperture stop 30 in the imaging system can vary freely as long as it serves substantially the function of an aperture stop. Thus, the color specific aperture stop 30 component may be positioned in front of or after an imaging lens system 13 as shown in FIGS. 4 and 5, respectively. If the imaging lens system 13 consists of several optical components, as shown in FIG. 5, it is also possible to position the aperture stop 30 between said lens components 13 (position B in FIG. 5).

Further, it is also possible to integrate the color specific aperture stop 30 in one or more of the lens components 13 as an optical coating or corresponding structure. Still, it is possible that the color specific aperture stop 30 comprises several individual components, which have been located in different positions, for example, some parts of the aperture stop in position A and some components in position B. The IR filter may be arranged, for example, as a coating on one or several lens components 13. Together these parts of the aperture stop, despite being partitioned in different spatial positions along the optical axis of the imaging system, work optically together in a desired way. It is clear that the imaging lens 13 may be any kind of a single or multicomponent lens or even a complicated lens system.

One possible construction of the aperture stop 30 for a RGB system is schematically shown in FIG. 6. According to a preferred embodiment, the color specific aperture stop 30 is basically an optically opaque plate 31 with optically transmissive, substantially circular areas 32,33 arranged coaxially with respect to the optical axis of the plate and having mutually different diameters. Said transmissive areas 32,33 have different spectral transmissive properties and define therefore different f-numbers for different primary colors. In case of a RGB type sensor, the center area 33 is arranged to be transmissive for all primary colors R,G,B. The center area 33 may also be substituted by a hole arranged in the plate. The diameter of this center area 33 is chosen to provide MTF performance suitable for the green primary color. Said center area 33 is encircled with a ring-like area 32 transmissive for R and B, but opaque for G. Therefore, for R and B a somewhat larger diameter aperture stop, and therefore a lower f-number and thus somewhat decreased MTF performance is provided.

As evident for a person skilled in the art, the center area 33 restricts the use of marginal rays with lower f-number from contributing to the formation of the green image, and thus the green image does not suffer from the optical aberrations caused by the lens 13 to such an extent as the red and blue images. As a result of this a better MTF performance is provided for the green color matching better with the spatial sampling frequency of the sensor 11.

For red and blue images a lower MTF performance can be allowed due the lower spatial sampling frequency of these colors. Simultaneously, the larger diameter aperture stop conveniently compensates for the lower sensitivity of the sensor 11 for red and blue as compared to the green color. This provides better sensitivity which is important especially in low light conditions.

Advantageously, the color specific aperture stop 30 also comprises an integrated IR cut-off filter, which in many applications is required to match the spectral sensitivity of the image sensor 11 better with that of the human vision. Without the IR filter, for example, the spectral response of a silicon based CCD detector extends beyond 1000 nm and complicates the control of exposure time and color balance suitable for producing naturally colored images. The IR filter can be simply provided by arranging the center area 33 and the ring-like area 32 surrounding it both to have a suitable IR cut-off wavelength, for example, between 700-800 nm.

With an integrated IR filter the color specific aperture stop 30 provides significantly simpler imaging system 20 with fewer optical components than the prior art system 10.

The color specific aperture stop 30 according to the invention can be manufactured, for example, using a thin glass or plastic plate and arranging said plate to be coated with opaque black and color transmissive areas. The coating processes suitable for this purpose are well-known in the art. Any single or multilayer spectrally selective optical coating structure may be used. Use of color absorbing materials instead of spectral coatings is also possible.

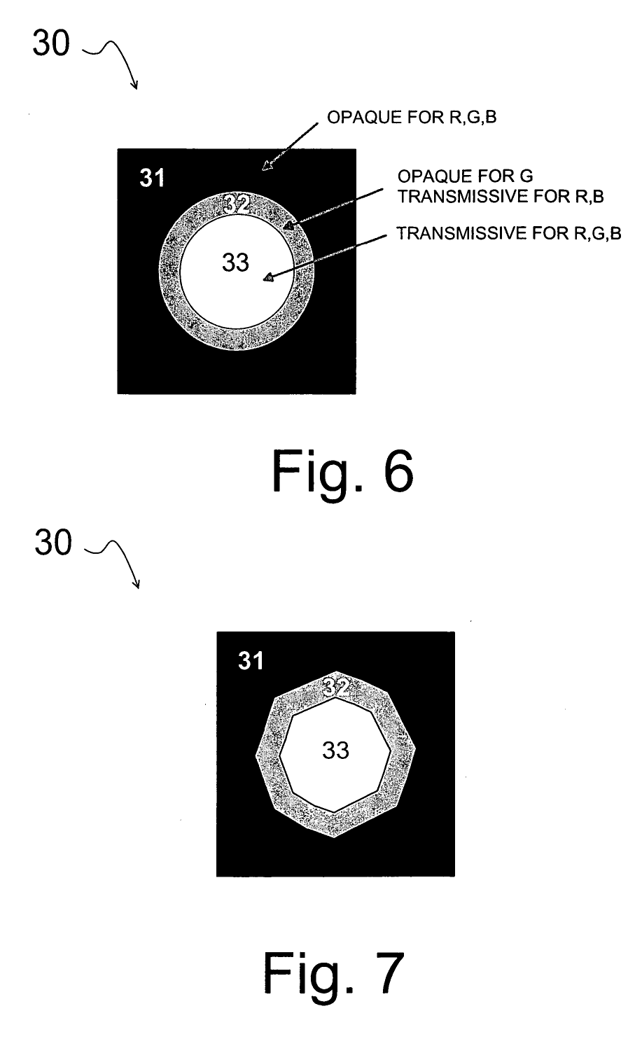

As shown in FIG. 7, the optically transmissive areas 32,33 of the color specific aperture stop 30 do not necessarily have to be circular, but also any other suitable, preferably axially symmetrical shapes may be used.

Table 1 and 2 present some optimization results for a single lens 13 system with color specific aperture stop 30. The construction of the imaging device corresponds to that basically shown in FIG. 4 and the structure of the color specific aperture stop 30 corresponds to that basically shown in FIG. 6.

Table 1 lists MTF values for each wavelength band R,G,B when a color specific aperture stop 30 with the properties evident from Table 2 is used in the imaging system 20.

The MTF performance of the imaging system was found to be good for green up to 45 Ip/mm spatial sampling frequencies. The sampling frequency for blue and red can be lower and because of this larger aperture size, smaller f-number, can be used. The f-numbers and relative amounts of light falling on the image sensor 11 are listed in Table 2.

From Table 2 it can be seen that the amount of blue and red light are 40% higher on the image sensor than the amount of green light. In typical imaging conditions the higher amount of blue light is especially important.

TABLE 1
MTF values for each wavelength band R, G, B with color
specific aperture stop. Terms “center” and “60% Image height”
refer to different positions in the image. Tangential and sagittal
refer to MTF values for lines having different alignments.

| | Blue | Green | Red |
|---|---|---|---|
| CENTER | | | |
| 15 lp/mm | 0.69299 | 0.90842 | 0.70066 |
| 30 lp/mm | 0.58348 | 0.70451 | 0.44812 |
| 45 Ip/mm | 0.50181 | 0.43708 | 0.17627 |
| 60% Image | | | |
| height | | | |
| (Tangential MTF) | | | |
| 15 lp/mm | 0.75702 | 0.69206 | 0.59833 |
| 30 lp/mm | 0.55611 | 0.63634 | 0.4581 |
| 45 lp/mm | 0.48147 | 0.54759 | 0.30666 |
| 60% Image | | | |
| height (Sagittal | | | |
| MTF) | | | |
| 15 lp/mm | 0.50375 | 0.87563 | 0.72784 |
| 30 lp/mm | 0.22796 | 0.64541 | 0.58964 |
| 45 lp/mm | 0.14977 | 0.43393 | 0.46762 |

TABLE 2
F-numbers and relative amount of light collected by the
image sensor for RGB wavelength bands.

| | Blue | Green | Red |
|---|---|---|---|
| f-number | 2.0 | 2.4 | 2.0 |
| RELATIVE LIGHT | 1.4 | 1 | 1.4 |

It should be understood, that in the above description an imaging system comprising basically from a RGB type image sensor and a single imaging lens was used only as an example, and it is therefore obvious for a person skilled in the art that the present invention is not restricted solely to the embodiments presented above, but it can be freely modified within the scope of the appended claims.

The type of the image sensor 11 is not restricted to RGB-type CCD or CMOS color sensors. The invention can applied with any kind of color image sensor based on any kind of color system or matrix layout as long as at least two of the primary colors of the sensor have substantially different spatial sampling frequencies. For example, the color system may be a CYGM (Cyan-Yellow-Green-Magenta) color system.

The different sampling frequencies for the different primary colors may be due to the different number of pixels representing said colors, or it may be due to the different size or spatial arrangement of the pixels. For example, an image sensor may have several layers each detecting a different primary color and said layers arranged so that in at least two of these layers the pixel sizes are different. It is also possible that the image sensor consists of several sensor chips each recording a different primary color. The image to these separate sensor chips may be divided using, for example, prism beam splitters or dichroic mirrors. A known example of such multi-chip color sensors are the 3CCD sensors used, for example, in digital video cameras.

It is also possible that the imaging sensor may be arranged to record only two different primary colors. Therefore, the term “primary color” should be interpreted in this connection very widely meaning simply the different wavelength bands that the different “color”pixels in the image sensor are arranged to detect. Therefore, the primary colors need not necessarily be the colors defined, for example, by a RGB- or CYGM-type color system. The number of primary colors in an imaging system according to the invention is not limited in any manner.

It is further possible that the color specific aperture stop may also comprise spectral filtering properties in order to balance the amount of light between different primary colors in order to reduce the requirements for the dynamic range of the image sensor. For example, the ring-like area 32 in FIG. 5 may be designed to transmit both red and blue colors, but also to attenuate slightly the red color compared to the blue color, if necessary. In similar manner, the center area 33 may be designed to attenuate the green color compared to the red and blue colors.

The imaging system according the invention may be preferably designed as a module, for example as an OEM module, which can be manufactured separately and easily installed into an electronic device needing to be equipped with imaging capabilities.

The electronic imaging system based on the use of an electronic image sensor and equipped with a color specific aperture stop according to the invention can be used in a wide variety of applications. Preferably, the invention is used in portable devices, like digital still or video cameras, where the compact size and lightweight construction are essential. Such digital cameras are nowadays integrated to many kind of portable devices, including, for example, mobile phones or other wireless communication devices. The invention may also be used in non-portable devices, such as web cameras or other computer related imaging devices.

1. A color imaging system comprising at least one electronic color image sensor and an imaging lens system forming an optical image on said image sensor, said image sensor having substantially different spatial sampling frequencies for at least two different colors, wherein the imaging system further comprises a color specific aperture stop defining substantially different aperture sizes for said at least two different colors.

2. The imaging system according to claim 1, wherein the color specific aperture stop is arranged to define the highest f-number for the color having the highest spatial sampling frequency.

3. The imaging system according to claim 1, wherein said color specific aperture stop is formed from optically transmissive areas arranged coaxially with respect to the optical axis of the lens system and said areas having their spectral transmissive properties arranged to be mutually different.

4. The imaging system according to claim 3, wherein said optically transmissive areas are arranged to be substantially circular in shape in the plane perpendicular to the optical axis.

5. The imaging system according to claim 3, wherein the spectral transmissive properties of said areas are arranged to balance the amount of light between the at least two different colors in order to reduce the requirements for the dynamic range of the image sensor.

6. The imaging system according to claim 3, wherein said color specific aperture stop is formed on an otherwise optically opaque, preferably thin plate arranged in the vicinity (A,B,C) of the lens system.

7. The imaging system according to claim 3, wherein said color specific aperture stop is integrated in the lens system.

8. The imaging system according to claim 7, wherein said color specific aperture stop is arranged on one or multiple surfaces of the lens system.

9. The imaging system according to claim 3, wherein said color specific aperture stop is partitioned into different spatial positions along the optical axis of the lens system.

10. The imaging system according to claim 1, wherein said color specific aperture stop further comprises an integrated IR cut-off filter.

11. The imaging system according to claim 1, wherein the image sensor is a silicon based digital matrix sensor, for example a CCD (Charged Coupled Device) or a CMOS (Complementary Metal Oxide Semiconductor) sensor.

12. The imaging system according to claim 1, wherein the image sensor is a RGB-type sensor based on Bayer color matrix layout.

13. The imaging system according to claim 12, wherein the color specific aperture stop is arranged to define a higher f-number for the green primary color compared to the red or blue primary colors.

14. The imaging system according to claim 1, wherein the color specific aperture stop is arranged to be easily interchangeable.

15. The imaging system according to claim 1, wherein the imaging system is integrated into a digital still or video camera.

16. The imaging system according to claim 15, wherein said digital still or video camera is integrated into a wireless communication device, for example, into a mobile phone.

17. A method in a color imaging system where an imaging lens system forms an optical image on at least one electronic color image sensor, said image sensor having substantially different spatial sampling frequencies for at least two different colors, wherein substantially different aperture stop sizes are defined for said at least two different colors using a color specific aperture stop.

18. The method according to claim 17, wherein the highest f-number is defined for the color having the highest spatial sampling frequency.

19. The method according to claim 17, wherein the f-numbers are defined using a color specific aperture stop formed from optically transmissive areas arranged coaxially with respect to the optical axis of the lens system, and said areas having their spectral transmissive properties arranged to be mutually different.

20. The method according to claim 19, wherein said optically transmissive areas are formed to be substantially circular in shape in the plane perpendicular to the optical axis.

21. The method according to claim 17, wherein the method is applied in an color imaging system integrated into a digital still or video camera.

22. The method according to claim 21, wherein said digital still or video camera is integrated into a wireless communication device, for example, into a mobile phone.
